(19) United States
(12) Patent Application Publication
(10) Pub. No.: US 2014/0280921 A1
(43) Pub. Date: Sep. 18, 2014

(54) DEVICE AND METHOD FOR DETECTING AND VISUALIZING NETWORK HEALTH

(71) Applicant: TRANE INTERNATIONAL INC., PISCATAWAY, NJ (US)

(72) Inventors: Christopher Conrad VanderKoy, Saint Paul, MN (US); Bryan Heinle, Woodbury, MN (US); Douglas Peterson, White Bear Lake, MN (US); Tedd Preston Johnson, La Crosse, WI (US); Joel C. VanderZee, La Crosse, WI (US); Joshua van Tol, Winona, MN (US)

(73) Assignee: TRANE INTERNATIONAL INC., PISCATAWAY, NJ (US)

(21) Appl. No.: 14/216,354

(22) Filed: Mar. 17, 2014

Related U.S. Application Data
(60) Provisional application No. 61/799,252, filed on Mar. 15, 2013.

(51) Int. Cl. H04L 12/26

(52) U.S. Cl. CPC H04L 43/045
USPC 709/224

(57) ABSTRACT

Device and method for detecting and visualizing a wireless network health and/or health of network devices connected to the wireless network. The wireless network health is detected based on one or more link quality indication (LQI) to indicate the strength of the communication link between the network devices. The wireless network health is displayed in a visualization on a computer display in real time or near real time so that the quality of the wireless network communication and health of the network devices can be quickly and easily understood by a user.

### FIELD

This disclosure generally relates to a device and method for detecting and visualizing a wireless network status in real time.

### BACKGROUND

A building control network for a heating, ventilation, and air conditioning (HVAC) system can include a BACnet using wired and wireless connections, interconnecting multiple BACnet devices (controllers) for controlling various heating, ventilation, and air conditioning devices.

### SUMMARY

The embodiments disclosed are directed towards a device and method for detecting and visualizing health (e.g., status) of a wireless network and/or network devices connected to the wireless network. Embodiments herein are directed towards detecting the health of the wireless network and/or network devices in real time. Embodiments herein are directed towards displaying a visualization of the wireless network health and/or health of network devices in real time on a computer display (e.g., a workstation, desktop computer, a mobile computer device, etc.). The term “health” is used herein to mean status or condition of a devices and/or a group of devices that are configured to communicate with each other. For example, a health of a device can include a power level of a battery, the device's connectivity condition to other devices in the wireless network, the device's communication link strength to its neighbor devices, etc. For example, a health of a network can include an overall quality of the network topology, redundancy of network connections, etc. The network health information displayed can include, for example, one or more of number of wireless devices, number of low batteries, number of medium batteries, number of good batteries, average transmission time, worst transmission time and address, and number of communication lost devices. The network health information can be accessed via a system controller (SC) and/or a service tool unit (TU).

### BRIEF DESCRIPTION OF THE DRAWINGS

Referring now to the drawings in which like reference numbers represent corresponding parts throughout.

FIG. 1 illustrates an exemplary schematic diagram of detecting and/or visualizing a network health displayed on a computer display, according to an embodiment.

FIG. 2 illustrates an exemplary schematic diagram of detecting and/or visualizing a network health displayed on a computer display, according to an embodiment.

FIG. 3 illustrates an exemplary schematic diagram of detecting and/or visualizing a network health displayed on a computer display, according to an embodiment.

FIG. 4 illustrates an exemplary schematic diagram of detecting and/or visualizing a network health displayed on a computer display, according to an embodiment.

FIG. 5 illustrates an exemplary schematic diagram of detecting and/or visualizing a network health displayed on a computer display, according to an embodiment.

FIG. 6 illustrates an exemplary schematic diagram of detecting and/or visualizing a network device health displayed on a computer display, according to an embodiment.

### DETAILED DESCRIPTION

This disclosure is directed to devices and methods for a method detecting and visualizing a wireless network (e.g., ZigBee) health and/or health of network devices (e.g., wireless connection interface (WCI)) connected to the wireless network. The wireless network health is detected based on one or more link quality indication (LQI) to indicate the strength of the communication link between the network devices. The wireless network health is displayed in a visualization on a computer display in real time or near real time so that the quality of the wireless network communication and health of the network devices can be quickly and easily understood by a user. Some of the embodiments include methods for automatically gathering network information and displaying the network information on a display of a computer, wherein the method includes the computer determining a link quality for one or more nodes connected via the network; the computer analyzing the structure of the network; and the computer displaying the network information on the display of the computer. For example, the computer can display the network information in graphical format using images (e.g., colors, shapes, icons, etc.). For example, the computer can display the network information in text and/or numbers (which can also include various colors, typefaces, fonts, etc.). For example, the computer can display the network information using a combination of graphics, text, and/or numbers.

FIG. 1 illustrates a wireless network 10 wherein the wireless network's 10 topology has been determined based on detection of network devices, and connection speed information of the network devices have been detected. Further, based on the detected source routes, the structural information of the network can be determined (for visualization of the network structure).

The wireless network's 10 health information can be gathered by a SC 40 that is connected (via wire or wirelessly) to a coordinator wireless communication interface WCI 41 and WCI 42. The WCI 41 is wirelessly connected to a plurality of network devices 201, 202, 203, 204. The communication speed detected between the WCI 41 and the network device 201 is 20 ms 51. The communication speed detected between the WCI 41 and the network device 202 is 20 ms 52. The communication speed detected between the WCI 41 and the network device 203 is 40 ms 53. The communication speed detected between the WCI 41 and the network device 204 is 50 ms 54. The WCI 42 is wirelessly connected to network device 301. The communication speed detected between the WCI 42 and the network device 301 is 20 ms 61. Further, each of the network devices' 201, 202, 203, 204 battery level can be detected by or reported to the SC 40. Thus, the health information about each of the network devices 201, 202, 203, 204 (e.g., their battery levels) can be visually displayed, as shown by a green bar 211 indicating good battery life for the network device 201, a yellow bar 212 indicating medium (or OK) battery life for the network device 202, a green bar 213 indicating god battery life for network device 203, a red bar 214 indicating poor (or bad) battery life for the network device 204, and a green bar 311 indicating good battery life for device network device 301.

FIG. 2 illustrates that the same network health information shown in FIG. 1 can be determined by using a TU 43 on the network 12, instead of using the SC 40 and/or WCI 41, 42.

The embodiments herein can detect and/or determine LQI of each network device (e.g., node) in the wireless network. The embodiments are capable or rapidly (e.g., in real time) collect LQIs between the network devices (e.g., nodes) and determine the wireless network's topology (e.g., a snap shot of the network), and/or an overall configuration of the nodes and how the nodes are linked to each other. Based on the LQIs and the network topology, the embodiments herein are directed towards evaluating the wireless network's redundancy. Further, the embodiments herein are directed towards providing a visual display of the network health and other network information to a user. For example, LQI quality can be rated numerically, symbolically, with icons, color, shape or otherwise visually to indicate a gradient or quantized levels of visually representing the quality of the communication link between the nodes (and/or the network). Further, pictograms like arrows between nodes can show asymmetric qualities, which can be further enhanced by use of different colors (e.g., green, yellow, red, etc.) or numerical values to represent quality of the link.

The process of getting the LQI ratings from each node can be done in several ways. In a “ZigBee” standard method, a message is sent to a node requesting its neighbor tables, starting with index “n.” Each response to the message contains two full neighbor table entries, which contains information such as incoming cost, outgoing cost, short addresses, long addresses, age, etc. The querying node then repeats this process, incrementing n by two each time until all table entries are fetched. This process is very slow, and because of the dynamic nature of neighbor tables, this process can fetch a completed table with either missing or duplicated entries (dynamic quality of the table can change between the first and the last read). This method could be made to work, but it would be very slow, and require a lot of extra handling of corner cases and checking of data.

According to an embodiment, a process for retrieving LQI ratings from each node can include requesting neighbor table information from either to a single node or to a larger group of nodes (either broadcast or multicast). When the request is made, the message is processed at the receiving node, which collects basic information for each neighbor table entry in the device in one operation. Then the short address of the neighbor is collected. The incoming cost and the outgoing cost can be collected and/or the LQI for each neighbor can be collected. Only valid entries are retrieved for sending (this is not the case with the ZigBee standard method described above, which can send invalid entries and requires additional processing to weed out (filter) the information based on their status). The resulting message is then sent back to the requester. Upon receipt of the resulting message, the requester should have a complete set of the LQIs from the neighbor table of that device as it existed at the time the target device processed the request. This embodiment of the method is significantly faster than the ZigBee standard method, and the quality of the data is better, because there is no need to look for errors (e.g., missed entries, doubled entries, etc.). Based on the lists of neighbors with LQIs from all the devices in the network, the embodiment can define an undirected graph with nodes corresponding to the network devices and edges between each pair that are neighbors with LQIs in both directions (i.e., LQIs better than some threshold rating). For example, a threshold of 240 (on the LQI scale of 0-255) can be used. As another example, one can decide to include edges where one LQI is above the threshold, especially if the other LQI is above a second threshold. If the resulting graph is not connected (e.g., the LQI is too bad), then the redundancy level is zero. Otherwise, the embodiment can determine a minimal set of nodes that can be removed such that the remaining graph is disconnected. That minimal number of nodes is the redundancy level. Generally, the higher the minimal set of nodes, the better the network health (because a chance that the network can fragment is low). Most data can be communicated to or from the coordinator device. The process includes looking for a minimal set of other nodes for removal, and search for sets smaller than some limit. Searching up to three devices to remove can be done because redundancy levels four or greater are all more than sufficient. This saves time compared to searching for larger sets to remove in a large, highly redundant network.

The term “redundancy” is related to “vertex-connectivity” of the graph (visual representation of the network topology), and a minimal set of nodes to remove is a minimal “vertex cut” or “separating set.” According to Menger's Theorem, the vertex-connectivity is also the minimal number of independent paths from one node to another. Redundant good paths are alternate routes available for the mesh network to use. High redundancy therefore contributes to high reliability.

Accordingly, the process according to an embodiment includes:
1) Get source routes to determine the structure of the network graph that is to be displayed.
2) Get LQI ratings from each node to determine what to display on the arrows between nodes (green, yellow, red) or a numerical value in the case of the engineering version of the tool.
3) Synthesize the gathered information into a graphical format (for example, using a Graphviz).

Collection of the LQI responses can be done before the source routes. The responses from all the nodes have the side effect of ensuring that the source routes are up to date, and it is better to read the source routes after any updates than to possibly read some out-of-date routes.

Accordingly, the process according to another embodiment includes:
1) Get LQI ratings from each node to determine what to display on the arrows between nodes (green, yellow, red) or a numerical value in the case of the engineering version of the tool.
2) Get source routes to determine the structure of the network graph that is to be displayed.
3) Synthesize the gathered information into a graphical format.

Sending the request as a broadcast increases the speed and can obtain the neighbor information from all devices at nearly a single point in time (as fast as the broadcast can propagate). A delay in the responses can be added (random, or based on short address, or whatever) so that responses would not be lost due to network congestion (e.g., when there are too many devices in the network). LQI for outgoing and incoming can be ranked in hexadecimal, with a range from 0 to ff, or a range of color codes.

FIGS. 3-5 illustrate schematic examples of visualization of the network health according to an embodiment. Each of the user interfaces 14, 16, 18 displays a group of selectable views 300 that a user desires to view. The group of selectable views 300 includes Network View 301, Sensor SS View 302, and Batt Life View 303. In FIG. 3, the user interface 14 shows what is displayed when the Network View 301 is selected. In FIG. 4, the user interface 16 shows what is displayed when the Sensor SS View 302 is selected. In FIG. 6, the user interface 18 shows what is displayed when the Batt Life View 303 is selected.

In FIG. 3, the user interface 14 displays a graph 310 of the network (e.g., network topology based on LQIs and/or source routes of network devices). The SC 40 and the TU 43 are shown to be connected to the network. SC 40 is connected to a device 100, which is connected to devices 101, 102, 109, and 107. The device 107 is colored “red” in the user interface 14 to indicate that the node's health is poor. The device 101 is connected to devices 122, 106, 118, 113, and 103. The device 113 is colored “yellow” to indicate that the node's health is not very good. The device 102 is connected to devices 104, 105 and to the TU 43. The device 104 is colored “yellow” to indicate that the node's health is not very good. The device 109 is connected to the device 108. Most of the devices SC 40, TU 43, 100, 101, 122, 106, 118, 103, 102, 105, 109, 108 are colored “green” to indicate that the node's health is good.

In FIG. 4, the user interface 16 displays a graph 312 of the network, having the similar topology of graph 310 as shown in the user interface 14, but displaying different kind of health information. The graph 314 displays signal quality at the nodes of the network (e.g., LQI, signal strength, etc.). In the graph 312, most of the nodes show good signal health (green colors), except for node 113, which shows a yellow (not all bars) indicating that the signal health is not as good as it could be.

In FIG. 5, the user interface 18 displays a graph 314 of the network, having the similar topology of graph 310 of the user interface 14 and/or graph 312 of the user interface 16. The user interface 18 displays the battery levels of the nodes in the network. In the graph 314, most of the nodes show good battery health (green colors), except for node 103, which shows a yellow (not fully charged) indicating that the battery health is not as good as it could be.

Each of the user interfaces 14, 16, 18 includes another group 400 of selectable security measures, wherein the encryption key can be selected to be on 401 or off 402.

FIG. 6 shows a schematic example of visualization of the network device health according to an embodiment. The detailed view display interface 20 is displayed when a user requests more specific information about a particular device. The interface 20 includes device identification and health information 500 for UC400 506, along with its software version number, and an icon 501 which can be selected to update/upgrade the software (e.g., “Upgrade: SW”). Device health can include software versions running on the device, wherein an outdated software version would result in the device being reported as being in not good or poor health. The interface 20 includes WCI 507 identification and health information 502, along with its software version number, and an icon 503 which can be selected to update/upgrade the software (e.g., “Upgrade: SW”). The interface 20 includes wireless display sensor (WDS) 508 identification and health information 504, along with its software version number, and an icon 505 which can be selected to update/upgrade the software (e.g., “Upgrade: SW”).

With regard to the foregoing description, it is to be understood that changes may be made in detail without departing from the scope of the present invention. It is intended that the specification and depicted embodiment to be considered exemplary only, with a true scope and spirit of the invention being indicated by the broad meaning of the claims.

What is claimed is:

1. A method for automatically gathering network information and displaying the network information on a display of a computer, comprising:
the computer determining a link quality for one or more nodes connected via the network;
the computer analyzing the structure of the network; and
the computer displaying the network information on the display of the computer.

2. The method as in claim 1, wherein the computer analyzing the structure of the network includes analyzing network health information; and the computer displaying the network information includes displaying the network health information on the display of the computer.

3. The method as in claim 2, wherein displaying the network health information includes displaying a status of one or more nodes that are configured to communicate with each other via the network.

4. The method as in claim 2, wherein displaying the network health information includes displaying a power level of a battery of one or more nodes that are configured to communicate with each other via the network.

5. The method as in claim 2, wherein displaying the network health information includes displaying communication link strengths of one or more nodes to a neighbor node, wherein the one or more nodes and the neighbor node are configured to communicate with each other via the network.

6. The method as in claim 2, wherein displaying the network health information includes displaying an overall quality of a topology of the network.

7. The method as in claim 2, wherein displaying the network health information includes displaying a redundancy of network connections of the network.

8. The method as in claim 2, wherein displaying the network health information includes displaying information for one or more wireless devices, wherein the information includes number of low batteries, number of medium batteries, number of good batteries, average transmission time, worst transmission time and address, and number of communication lost devices.

9. The method as in claim 2, wherein displaying the network health information includes displaying a number of low batteries.

10. The method as in claim 2, wherein displaying the network health information includes displaying a number of medium batteries.

11. The method as in claim 2, wherein displaying the network health information includes displaying a number of good batteries.

12. The method as in claim 2, wherein displaying the network health information includes displaying an average transmission time.

13. The method as in claim 2, wherein displaying the network health information includes displaying a worst transmission time and address of the node which has the worse transmission time.

14. The method as in claim 2, wherein displaying the network health information includes displaying a number of communication lost devices.

15. The method as in claim 1, further comprising:
the computer detecting source routes of a network and determining a structure of the network.

16. The method as in claim 15, further comprising:
the computer displaying the structure of the network in a graphical format on the display of the computer.

17. The method as in claim 1, wherein the computer displaying the network information is displayed in a graphical format on the display of the computer.

18. The method as in claim 1, wherein the computer determining the link quality for one or more nodes includes each of the nodes gathering link quality data between the node and one or more of immediate neighbor nodes and transmitting the link quality data to the computer.
